(19) United States
(12) Patent Application Publication
(10) Pub. No.: US 2012/0054609 A1
(43) Pub. Date: Mar. 1, 2012

(54) Method and System for Providing a Personalized Starting Web Page

(75) Inventors: Ido Sher Sever, Sde Warburg (IL); Eytan Fishman, Herzliya (IL); Ethan Hall, Herzliya (IL)

(73) Assignee: WOOLIK TECHNOLOGIES LTD., Herzliya Pituach (IL)

(21) Appl. No.: 13/215,920

(22) Filed: Aug. 23, 2011

Related U.S. Application Data
(60) Provisional application No. 61/377,907, filed on Aug. 27, 2010.

(51) Int. Cl. G06F 3/01

(52) U.S. Cl. 715/709

(57) ABSTRACT

The invention relates to a client-server system for interactively creating a personalized starting page at a user's computer, which comprises: (a) a client wizard that interfaces between a user and a content unit which is located at said server, wherein said wizard guides the user through a process for the creation of said personalized starting page; and a content unit at said server for providing content to said wizard, wherein the user selects items from said content during said process for the creation of said personalized starting page; wherein said creation process involves automatic adaptation to the user at said wizard, with respect to said content.

### FIELD OF THE INVENTION

The present invention relates to the field of a starting Web page. More particularly, the invention relates to constructing a fully tailored starting Web page, using an adaptive wizard.

### BACKGROUND OF THE INVENTION

Starting Web page is a term, generally synonymous with gateway for World Wide Web (WWW) sites. Starting Web page allows users to connect to other Web sites, or to visit it as an anchor site when browsing the Internet. Usually, the starting Web page is the default Web page presented to the user while starting his browser. The default Web page presented while starting the browser is also referred as the browser's homepage. Many users access the information and services available on the Internet through a conventional starting Web page. Common starting pages types include portal, widget based, and index based web pages.

Portal sites usually offer an array of services and resources, such as e-mail, online shopping, news, weather, search engines, and the like, to their users. Portals provide an easy access to multiple content types, which otherwise would have been different entities altogether. There are general portals and specialized or niche portals. Some major general portals include Yahoo®, Excite™, Netscape, AOL, and etc. Examples of niche portals include Garden.com (for gardeners), Fool.com (for investors), and SearchNetworking.com (for network administrators). However, Portals usually provide limited or no access to web sites which are not part of the portal, and also encompass limited access to the popular sites which might be relevant to the user (e.g., the popular sites in the user's geographical location, the popular sites in the user's language, and etc).

In computing a web widget is a portable chunk of code that can be embedded-in and executed within any separate HTML-based web page by an end user. Web widgets help users to bring their favorite content to the desired web page, e.g., RSS widgets which display entries from RSS feeds. Widgets often take the form of on-screen tools (clocks, event countdowns, auction-tickers, stock market tickers, flight arrival information, daily weather etc.).

Several widget based sites provide their users enhanced customization ability for constructing their starting page, e.g., iGoogle, Netvibes, etc. Widget based sites offer a starting page that features the user's selected content. Widget based sites enable the user to customize his starting page. However, Widget based sites suffer from a tradeoff between personalization and complexity, namely the starting pages which offer a high level of personalization require high constructing effort and computer skills, whereas the more “user friendly” starting pages have only slight personalization capabilities.

Most Web sites are associated with a graphical logo. Usually, when users see a graphical logo they recognize the Web site associated with it. Some Web pages present small graphical logos of a variety of web sites, normally when users click a specific logo they browse to the Web site associated with it. Such logo is referred hereinafter as “logo-link”. Several sites, e.g., http://www.allmyfaves.com provide a starting page that presents to the user an index of logo-links. By clicking a specific logo-link that appears in the index, the user browses to the site associated with the clicked logo-link. Web sites which present an index that contains selected logo-links are referred hereinafter as “index based site”.

Even though some index based sites enhance their usability by categorizing their index, they usually offer a static index arrangement, predetermined index presentation, and at the most limited customization ability. In most cases the index in index based sites is not personal, and does not contain the user's favorite and most frequently used Web sites. Even in cases wherein an index based site provides some personalization, selecting the content for creating the index usually involves locating the desired content within large lists. For example, selecting the desired logo-links to create an index from among hundreds of logo-links.

A wizard is a computer utility designed to simplify the execution of lengthy or complicated tasks. In a Graphical User Interface (GUI), a wizard consists of a sequence of menus through which the user navigates in order to achieve a specific objective such as copying files and folders, installing software, etc.

A Content Delivery Network or Content Distribution Network (CDN) is a system of computers containing copies of data, placed at various points in a network so as to maximize bandwidth for access to the data from users throughout the network. By utilizing a CDN, a user can access a copy of the data near by, as opposed to accessing the same central server by all users. Utilizing a CDN avoids the bottleneck otherwise created near the central server. Content types include web objects, downloadable objects (media files, software, and documents), applications, real time media streams, and other components of internet delivery (DNS, routes, and database queries).

A Web Content Management System (WCMS) is an application used to create, manage, store and deploy content on web pages. WCMS is designed to simplify the publication of Web content to Web sites and mobile devices, in particular allowing content creators and managers to submit, modify, and remove content without requiring technical knowledge of HTML or the uploading of files.

In telecommunications, scalability is a desirable property of a system, a network, or a process, which indicates its ability to either handle growing amounts of work in a graceful manner or to be readily enlarged. For example, scalability refers to the capability of a system to increase total throughput under an increased load when resources (typically, hardware or users) are added. Scalability is a highly significant issue in electronics systems, databases, routers, and networking.

A scalable Web system is said to be a system in which an increase in the number of users or the content they consume does not require extensive changes in the system architecture or the extensive addition of system resources, therefore, executed at relatively low costs. A huge amount of time and money is invested to solve scalability problems in web systems which experience significant growth in the number of users and in the content that users consume. Companies try to deploy and run high-volume production Web sites while solving software, hardware, hosting, and Internet infrastructure problems.

Another drawback of many starting pages is their slim compatibility to mobile devices and inability to import a personalized starting page that was created on a personal computer to a mobile device. Typically, mobile devices have limited input capabilities which make this task tedious for many users.

It is therefore an object of the present invention to provide a system for assisting a user to create a starting page fully tailored for his specific needs.

It is another object of the present invention to provide a short and easy process for guiding the user through the creation of the starting page.

It is another object of the present invention to provide a system for assisting a user to create a personal index containing selected logo-links.

It is another object of the present invention to provide relevant content targeted for the user through the creation of the starting page.

It is another object of the present invention to provide a system supporting said starting page after its creation.

It is still another object of the present invention to provide a system for managing a starting page in which data transfer and the scalability overhead are reduced.

It is still another object of the present invention to provide said system for the creation and management of starting page in which minimal use of the keyboard is required.

It is still another object of the present invention to provide a starting page easily adaptive to mobile platform devices.

Other objects and advantages of the invention will become apparent as the description proceeds.

### SUMMARY OF THE INVENTION

The invention relates to a client-server system for interactively creating a personalized starting page at a user's computer, which comprises: (a) a client wizard that interfaces between a user and a content unit which is located at said server, wherein said wizard guides the user through a process for the creation of said personalized starting page; and a content unit at said server for providing content to said wizard, wherein the user selects items from said content during said process for the creation of said personalized starting page; wherein said creation process involves automatic adaptation to the user at said wizard, with respect to said content.

Preferably, the automatic adaptation is based on (i) basic data related to the user, or (ii) user selections in the wizard, or both (i) and (ii).

Preferably, the automatic adaptation of said wizard includes adapting one or more of said wizard features, said features being taken from the group consisting of viral behavior, visual design, wizard explanation, display frequency, and display intensity.

Preferably, the automatically adapted content is taken from the group consisting of suggested images, suggested logo-links, suggested widgets, ads, promotions, offers of services, and offers of products.

Preferably, the wizard guides the user step by step through the creation of the personalized starting page, in each said step the wizard presents the content to the user, and said user selects from it content for his starting page.

Preferably, the personalized starting page supports aspects of content taken from the group consisting of sites, feeds, backgrounds, localized texts, and widgets.

Preferably, the basic data related to the user is taken from the group consisting of location, language, marketing campaign, and preference statistics.

Preferably, the content unit comprises a location server for identifying the location of the user.

Preferably, the content unit comprises a Content Delivery Network (CDN), and said CDN stores files comprising the content provided to the wizard.

Preferably, the content unit comprises a Web Content Management System (WCMS) that stores the content items which are used for generating the CDN files, and said WCMS constantly updates its content and generates an up-to-data files for the CDN.

Preferably, the content unit comprises an analytics server for tracking the user's selections in said wizard, and adapting accordingly the content delivered to said wizard.

Preferably, the content selected by the user during the personalized starting page creation is stored in a settings file, which is saved locally on the user's computer.

Preferably, the settings file further comprises basic data related to the user and personal data regarding the user that was emerged during his selections.

Preferably, the system further comprises a setting server for storing a global copy of the user's settings file for backup.

Preferably, the entrances to the personalized starting page leads to only access to the local copy of the user settings file, for reducing the data transfers and scalability overhead.

Preferably, the personalized starting page is created on a mobile device, and the features are adapted to mobile platform devices.

Preferably, the personalized starting page is importable from a personal computer to a mobile device and vice versa.

Preferably, the content items which create the starting page can be resized and repositioned to achieve a modular and user-friendly starting page.

### BRIEF DESCRIPTION OF THE DRAWINGS

In the drawings:

FIG. 1 schematically illustrates the system of the present invention in block diagram form;

FIG. 2 is an example of a tailored starting page created using the adaptive wizard of the present invention;

FIG. 3 is one exemplary embodiment of a menu provided to the user in his personalized starting page; and

FIG. 4 is an example of a personalized starting page created for a mobile platform.

### DETAILED DESCRIPTION OF THE INVENTION

Presently, each user is provided with the option within his browser to define one specific Web page as his main home page, namely the page that is loaded when the user starts his browser. The user can select such a home page from any page existing in the Web. Users usually set their main home page to be the Web page which they find most comfortable as a starting page. Home pages considered by many users to be comfortable starting pages include portal sites, widget based sites, and index based sites. However, those types of sites usually don't provide a short and easy process for creating a personalized starting page.

The present invention enables each user to easily create his own starting Web page (also referred herein as personalized starting page) using a wizard. The personalized starting page, as created by the user supports various capabilities for further personalization such as access to logo-links of selected sites, feeds, localized texts, widgets, selection of background images, etc. In one embodiment the starting Web page comprises a personal index of logo-links which provides the user access to his preferred Web sites.

The wizard is provided to the user by the Host of the Web site where the user generates his starting Web page. In one embodiment, the wizard is an adaptive GUI which guides the user a step by step for the creation of the personalized starting page. The wizard automatically adapts to the user and provides him in the first step content based on some basic knowledge of his characteristics, such as: location, language, marketing campaign from which the user has accessed the Web site, etc. During each next step in the wizard, the system adapts the wizard on the fly according to the basic knowledge of the user characteristics, and the personal data regarding the user that emerged during his previous selections in the wizard.

The automatic adaptation to the user can include adaptation of only the wizard structure and behavior, or only the content suggested by the wizard, or both. The automatic adaptation can be based on basic data related to the user characteristics, or on the user selections in the wizard, or on both. The adaptation of the content includes suggesting the user the background images, logo-links for the personal index, widgets, ads, promotions, services, and products which fit him most for creating his starting page and his personal index. Besides the content adaptation the wizard can adapt itself to the user. The visual design of the wizard GUI can include different design themes (look and feel) which fit different users. The behavior of the wizard is capable of adapting to fit the user's origin and selections. Display frequency and intensity of hints, tooltips, tutorials, and other explanations regarding the product features are adapted to how much the user uses those features, and how the user reacts to the tooltips (if he closes them or uses them). The viral behavior of the present invention is also capable of adapting to the user's behavior. For example, giving the user the option to prepare a personalized starting page for a friend or to share his page or part of it with others is adapted to the user's behavior, namely, how active and ‘social’ he is.

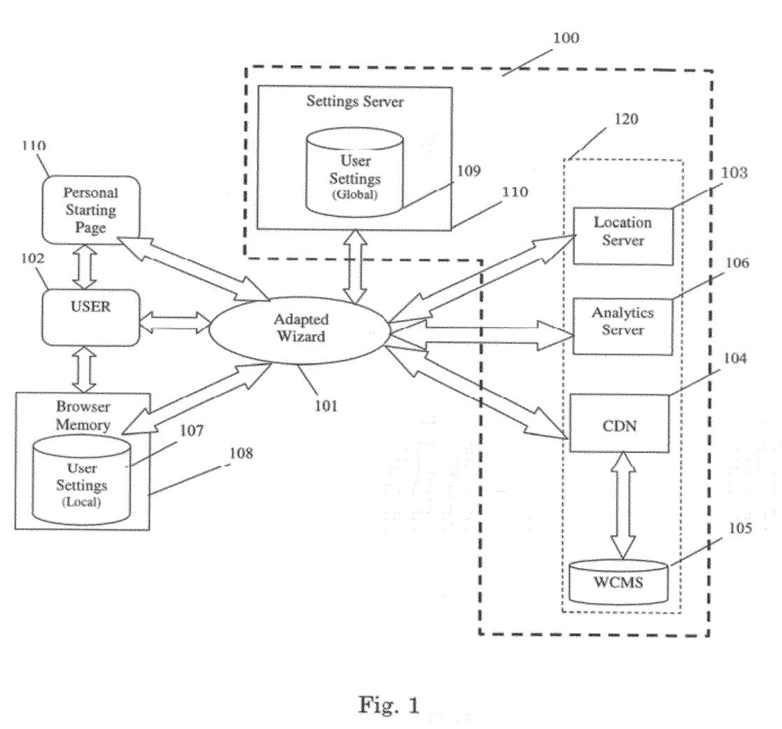

FIG. 1 schematically illustrates the system of the present invention in block diagram form. An automatically adaptive wizard 101 guides a user 102 through the steps for tailoring his personalized starting page 110. When the user first accesses the Host 100 site, adaptive wizard 101 conveys some basic data regarding this user (e.g., one or more of the IP address, the marketing campaign, etc.) to a content unit 120. Content unit 120 encompasses servers targeted for handling the content and providing a content having two levels of adaptation, namely initial adaptation based on basic data related to the user, and on the fly adaptation based on the user selections in the wizard.

Said basic data which is initially conveyed to the content unit 120 is received by the location server 103. The location server 103 identifies the general location of the user (such as, country, state, city, university etc.) from said basic data from the wizard. Typically, the user may access the Host site from a specific marketing campaign in which a link to the Host Web site is published. The details of the marketing campaign that are relevant for the wizard are stored in a Content Delivery Network (CDN) 104 and are retrieved from the CDN 104 by the wizard. CDN 104 contains static files with data structures that hold content data associated with specific locations and marketing campaigns.

For example, if a user reaches the Host site from a marketing campaign published in a specific financial portal in Japan, the wizard retrieves from the CDN the static files that contain the data most relevant for this specific user and the wizard adapt itself to the user. In this example, the wizard retrieves from the CDN one or more files that contain reference to Japanese Web sites, several sites that are economy oriented, backgrounds of Japan's sceneries, widgets that are known to be preferred by Japanese, general data in Japanese, etc. In addition, the wizard GUI design theme, namely look and feel is automatically adapting to financial oriented users.

Since the user accessed the Host site from an economy related marketing campaign, the wizard may also suggest widgets related to the economy world, for example, a widget which performs currency exchange calculations. The language of the user is also considered while providing the initial adaptive content and in the next steps for the creation of the personalized starting page. For example, an English speaking Canadian will receive a different wizard than a French speaking Canadian. An English speaking user from Canada will see more logo-links of English speaking sites in the wizard than a French speaking Canadian.

As mentioned hereinabove the data files in the CDN 104 that are initially provided to the adaptive wizard 101 are relevant to the location, and language of the user, and to the marketing campaign from which the user has accessed the Host Web site. However, since sites and popular content in the Web change dynamically, a Web Content Management System (WCMS) 105, is utilized for keeping the files in the CDN up-to-date. The WCMS 105 holds content items (e.g., logo-links for the personal index, popular sites, widgets, backgrounds) that are used for generating the static files in the CDN. The WCMS constantly updates its content and generates up-to-date static files for the CDN. The files are cached in the browser memory 108, and a new copy is retrieved from the CDN only when the content in the WCMS associated with the CDN is updated, based on versioning of the data, thus giving performance benefits. In this embodiment the CDN automatically sends to the wizard the most up-to-date files according to the most updated content stored in the WCMS. This ensures that the user is always presented with the most up-to-date content.

The static files retrieved by the wizard from the CDN are cached by the browser. As long as a file is not modified, the wizard uses a local copy of the user settings file 107 which is stored in the browser cache, without contacting the CDN. Therefore the loading time of the wizard and the personalized starting page is reduced, and also the load on the CDN is reduced. The name of each static content file includes a version number. When the file (or one of the files it depends on) is modified, its version number is modified as well, so in the next time when the Wizard requires this resource, it gets the new updated file from the CDN, under the modified version name. Reducing the load on the CDN require less hardware to support the system, therefore improves the system scalability.

After receiving the first adaptive content from the CDN, the wizard guides the user step by step towards generating his fully tailored personalized starting page. During the user's steps, the wizard monitors the user selections, and forwards them to analytics server 106. Analytics server 106 tracks the user's selections in the wizard GUI, and accordingly suggests targeted content to the wizard. For example, if a user selects a background of surfers for his starting page, the content presented to him in the following steps is associated with sea and sport, e.g., logo-links of extreme sport sites, logo-links of sites related to water activities, adds offering surfing vacations, etc. In another embodiment, only the wizard adapts the content suggested to the user. In yet another embodiment the wizard is responsible for some adaptation and the analytics server is responsible for the rest.

The selections of the user during the personalized starting page construction and the initial data regarding his location and marketing campaign are all stored in a file associated with this specific user. This file is referred hereinafter as the User Settings File (USF). Besides the basic data related to the user, the USF can also store personal data regarding the user that was realized during the user's selections in the wizard GUI. A local copy 107 of the USF is stored in a local memory at the user's side. In this embodiment the local copy of the USF 107 is stored in the memory of the user's browser 108. A global copy 109 of the USF is stored in a settings server 110 of the Host. The settings server 110 holds a copy of the user's USF for backup purposes. If a user accidentally deletes his local USF copy, the system can provide him a new copy of the USF based on the global copy 109 saved in the settings server 110.

The local copy 107 saved in the browser memory 108 improves the access performance, and reduces scalability overhead. Each time the user accesses his personalized starting page, the wizard accesses the local USF copy 107. Therefore, the load of the data that transfers between the user and the settings server 110 is reduced. The local copy of the settings saves the wizard from having to query the server for the settings, thus reducing both server load and starting page load time. A reduction of the load on the settings server 110 reduces the marginal load for each additional user.

Therefore, further growth (in the number of users) requires less additional resources, e.g., less additional servers to support the users, comparing with traditional system which utilize only the global USF copy, hence the system is more scalable.

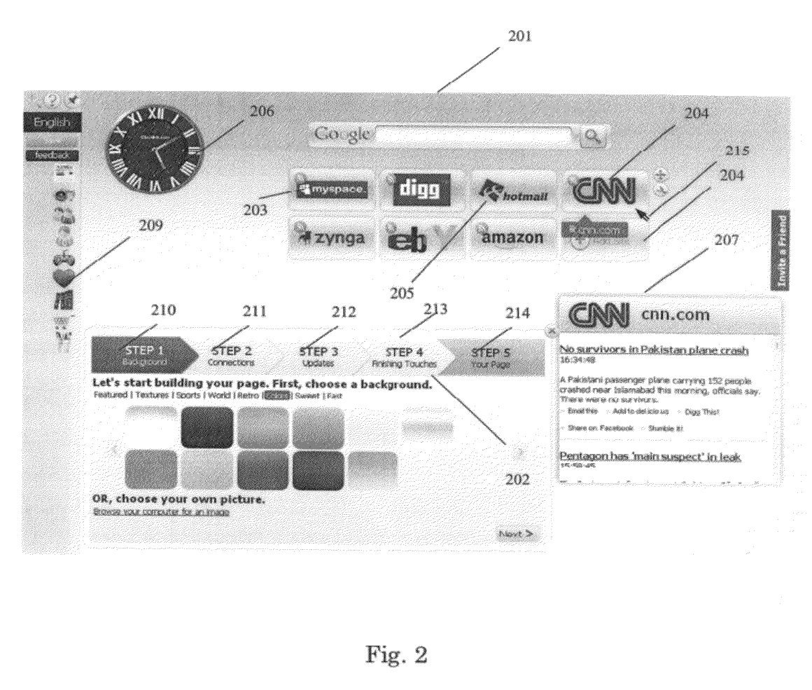

FIG. 2 is an example of a tailored personalized starting page 201 which is created using the adaptive wizard 202 of the present invention. In the embodiment of FIG. 2, the wizard guides the user to build his personalized starting page in five steps 210 through 214. The first step 210 prompts the user to select a background for his personalized starting page. The user may select an existing background or load his own background. In the next step 211, the user selects logo-links of sites from a list (not shown) adapted to him based on his location, language, marketing campaign, and the background which he has selected. The logo-links of the sites selected by the user are then added to an index displayed on the personalized starting page. After the logo-links are added, the user can navigate directly to the sites associated with those logo-links by clicking on them. The user has the ability to freely resize and reposition all the elements (e.g., logo-links, widgets, index, etc) on his starting page. Resizing elements is a key feature in achieving a modular and comfortable starting page. Due to the dynamic design usually characterizing starting pages, the ability to resize and reposition the elements enables the user to fully design and control his starting page, therefore the starting page is modular and user-friendly.

In this example, the user added the logo-link “myspace” 203 from a list of social networks, CNN site 204 from a list of news sites, hotmail site 205 from a list of Web-mails, ebay and amazon sites from a list of trading sites. The wizard also offers the user sites to add from a list of media sites, leisure sites, etc. In this embodiment, during each step of the process for creating the personalized starting page, the analytics server receives the selections of the user, analyses his preferences, and adapts the wizard to prompt in the next steps those sites that best suit the user characteristics. As a result, such sites receive preference upon less relevant sites hence appearing first in the lists provided to the user.

The automatically adaptive wizard 202 allows constructing a personalized starting page which is fully tailored for each specific user. The starting page offers managing capabilities to all aspects of content. Besides sites, the user can add any widget, e.g., a clock 206. Within the starting page, the user can easily add popular sites from a list of site logo-links relevant to the user's country. The entire process of the starting page creation can be performed without use of the keyboard, and solely by pointing, clicking and dragging by the cursor.

The wizard of the present invention provides an easy and fast method for constructing and managing the personalized starting page. As mentioned, the ease of personalization is related in a great part to the fact that it can be done without the use of the keyboard, namely, with several mouse actions. Thus, making it even easier to use in tablet devices with a touch screen, which do not have a standard keyboard, such as an iPad.

At any time, the user can open the wizard GUI 202 by clicking an icon available in his starting page, and repeat the steps 210-214 for re-constructing the personalized starting page, namely, adding, removing, and changing the content presented in the personalized starting page. In this embodiment, the user can avoid the inconvenience and inefficiency operation of launch-and-return from the starting page. The present invention allows the user to preview the sites added to his personalized starting page 201 by hovering over their logo-links. In the example of FIG. 2, the cursor 215 hovers over the CNN logo-link 204, and as a result, a CNN preview 207 is presented to the user.

The personalized starting page also supports the addition of sites which are not on the lists provided to the user during the personalized starting page generation. By simply clicking the “Add Site” icon 208, the user is allowed to insert a URL of a desired site. As a result, the index of the site requested is added to the personalized starting page. In this embodiment, the starting page also provides a menu 209 to the user.

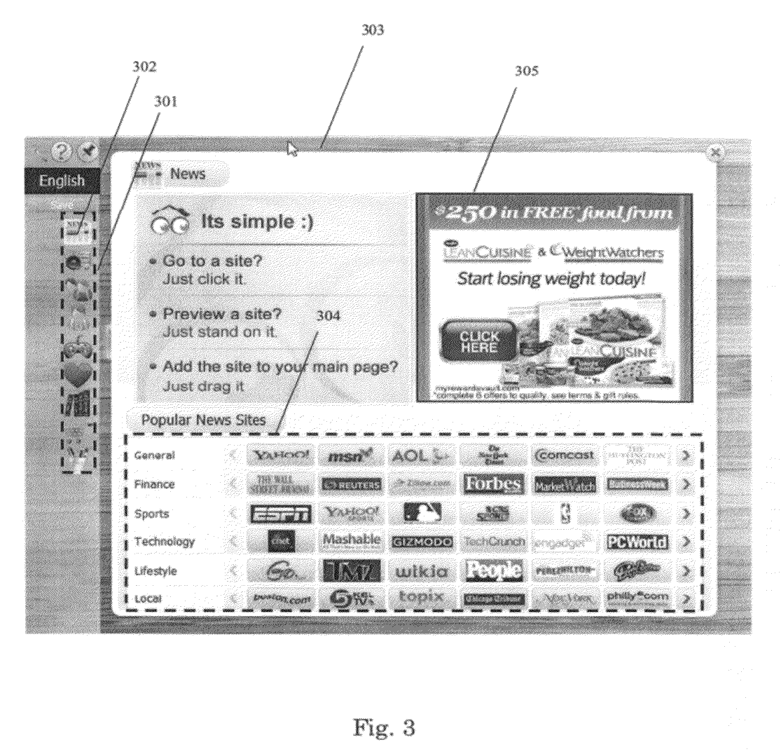

FIG. 3 is one exemplary embodiment of the menu 301 provided to the user in his personalized starting page. Menu 301 encompasses content categorized to specific subjects, e.g., news 302, media, community, business, entertainment, lifestyle, education, shopping, etc. By clicking a specific category the user opens a terminal 303 which presents data relevant for the selected category. In one embodiment, terminal 303 presents indexes 304 of popular Web sites related to the subject of the selected category.

The popular logo-links are also categorized. The user may add logo-links from the menu to the starting page. Employing the personalized starting page of the present invention, the user is literally one click away from his favorite sites and two clicks away from hundreds of popular sites relevant for him. Terminal 303 also presents advertisement targeted to the user according to the specific category selected and to prior knowledge the system has. For example, if an American user that his starting page contains many logo-links of sites associated with teenagers opens the preview of the media category, trailers in English of movies which are considered to be preferred by teenagers are presented to him on the area targeted for advertising 305.

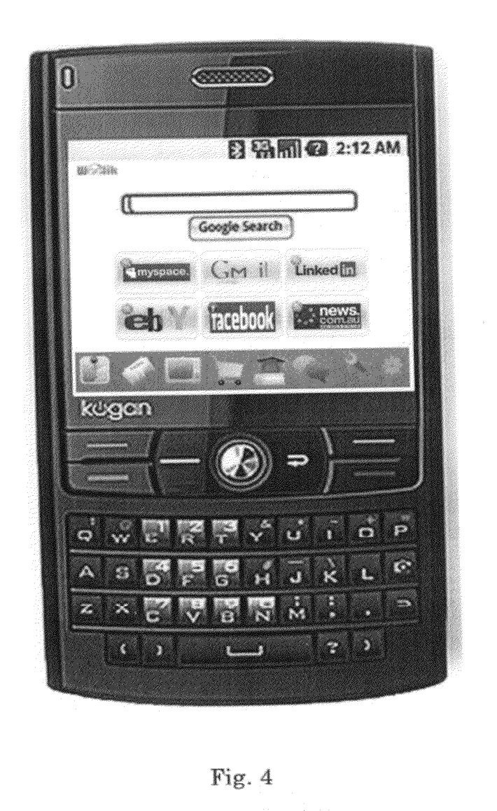

FIG. 4 is an example of a personalized starting page created for a mobile platform. The features of the system of the present invention make it easy to use with mobile devices. Once the personalized starting page is created, for example, on a computer, it can be loaded into a mobile device, without having to define it from scratch at the mobile device which typically has less comfortable input capabilities (such as a small keyboard) capabilities. In a first embodiment, the present invention allows a user to build a personalized starting page directly on his mobile device. The wizard allows the user to add logo-links without using a keyboard, by simply clicking to select them from a list presented to him. The system allows importing the settings of the starting page created on the mobile device directly to the computer.

In a second embodiment, the present invention enables the user to build his personalized starting page on his computer, where it is easy, and then to send the settings to his mobile device. The system also synchronizes between the computer and the mobile platform, and allows importing settings from the computer to the mobile device. The settings that are sent to the mobile device are automatically modified, in order to better suit mobile platform, (widgets are omitted, background is simplified or omitted, logo-links are enlarged relative to the display size, so that the user can easily recognize the logo of the selected site, etc). The user will of course have the option to add or remove sites from his mobile personalized starting page version.

Utilizing the mobile platform provided by the present invention, it is easier for a user to access his most visited sites. The index size is large enough for the user to easily view and use it. An easy access to the user's country most popular websites is provided via logo-links. The list of the popular websites provided on a mobile platform is adjusted to the ability of the mobile device. Supporting the features described hereinabove the personalized starting page can be easily imported from a personal computer to a mobile device and vice versa. An easy site preview is available for the mobile platform. This preview presents feeds from the websites selected by the user. This way the user can easily view the updated content of any site providing feeds from the same page without the need to navigate to this site.

The above examples and description have been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A client-server system for interactively creating a personalized starting page at a user's computer, which comprises:
a) a client wizard that interfaces between a user and a content unit which is located at said server, wherein said wizard guides the user through a process for the creation of said personalized starting page; and
b) a content unit at said server for providing content to said wizard, wherein the user selects items from said content during said process for the creation of said personalized starting page;
wherein said creation process involves automatic adaptation to the user at said wizard, with respect to said content.

2. A system according to claim 1, wherein the automatic adaptation is based on (i) basic data related to the user, or (ii) user selections in the wizard, or both (i) and (ii).

3. A system according to claim 2, wherein the automatic adaptation of said wizard includes adapting one or more of said wizard features, said features being taken from the group consisting of viral behavior, visual design, wizard explanation, display frequency, and display intensity.

4. A system according to claim 2, wherein the automatically adapted content is taken from the group consisting of suggested images, suggested logo-links, suggested widgets, ads, promotions, offers of services, and offers of products.

5. A system according to claim 1, wherein the wizard guides the user step by step through the creation of the personalized starting page, in each said step the wizard presents the content to the user, and said user selects from it content for his starting page.

6. A system according to claim 1, wherein the personalized starting page supports aspects of content taken from the group consisting of sites, feeds, backgrounds, localized texts, and widgets.

7. A system according to claim 2, wherein the basic data related to the user is taken from the group consisting of location, language, marketing campaign, and preference statistics.

8. A system according to claim 1, wherein the content unit comprises a location server for identifying the location of the user.

9. A system according to claim 1, wherein the content unit comprises a Content Delivery Network (CDN), and said CDN stores files comprising the content provided to the wizard.

10. A system according to claim 1, wherein the content unit comprises a Web Content Management System (WCMS) that stores the content items which are used for generating the CDN files, and said WCMS constantly updates its content and generates an up-to-data files for the CDN.

11. A system according to claim 1, wherein the content unit comprises an analytics server for tracking the user's selections in said wizard, and adapting accordingly the content delivered to said wizard.

12. A system according to claim 1, wherein the content selected by the user during the personalized starting page creation is stored in a settings file, which is saved locally on the user's computer.

13. A system according to claim 12, wherein the settings file further comprises basic data related to the user and personal data regarding the user that was emerged during his selections.

14. A system according to claim 12, further comprising a setting server for storing a global copy of the user's settings file for backup.

15. A system according to claim 12, wherein entrances to the personalized starting page leads to only access to the local copy of the user settings file, for reducing the data transfers and scalability overhead.

16. A system according to claim 1 wherein the personalized starting page is created on a mobile device, and the features are adapted to mobile platform devices.

17. A system according to claim 1 wherein the personalized starting page is importable from a personal computer to a mobile device and vice versa.

18. A system according to claim 1 wherein the content items which create the starting page can be resized and repositioned to achieve a modular and user-friendly starting page.
